(19) United States
(12) Patent Application Publication
(10) Pub. No.: US 2012/0263822 A1
(43) Pub. Date: Oct. 18, 2012

(54) CHECK VALVE

(75) Inventors: Christophe Halter, Selange (BE); Peter Adrian Looije, Newmarket (CA); Pierre Glaesener, Bissen (LU)

(73) Assignee: Husky Injection Molding Systems Ltd

(21) Appl. No.: 13/257,024

(22) PCT Filed: Mar. 3, 2010
(86) PCT No.: PCT/CA10/00255

§ 371 Date: Sep. 16, 2011

Related U.S. Application Data
(60) Provisional application No. 61/168,647, filed on Apr. 13, 2009.

(51) Int. Cl. F16K 21/04; B29C 45/23

(52) U.S. Cl. 425/564; 137/511

(57) ABSTRACT

A check valve for a screw is provided. The check valve includes a retainer tip, operable to be attached to a distal end of a screw shaft, the retainer tip defining at least one melt channel. A first ring is coaxially mounted to and rotationally-coupled with the retainer tip. A second ring is coaxially and slidably mounted to the retainer tip, and is operable to rotate relative to the retainer tip. The second ring is operable to reversibly move between an open position which permits melt to flow through the check valve and a closed position which prevents backflow of the melt.

### FIELD OF THE INVENTION

The present invention relates to injection molding machinery. More specifically, the present invention relates to check valves used in the barrels of an injection unit.

### BACKGROUND OF THE INVENTION

Some examples of known molding systems are: (i) the HyPET™ Molding System, (ii) the Quadloc™ Molding System, (iii) the Hylectric™ Molding System, and (iv) the HyMet™ Molding System, all manufactured by Husky Injection Molding Systems, Ltd.

The injection molding process typically comprises preparing a polymeric (or sometimes metal) material in an injection unit of an injection unit for melting, injecting the now-melted material under pressure into a closed and clamped mold, solidifying the material in its molded shape, opening the mold and ejecting the part before beginning the next cycle. The molding material typically is supplied to the injection unit from a hopper in the form of pellets or powder. The injection unit transforms the solid material into a molten material (sometimes called a “melt”), typically using a feed screw, which is then injected into a hot runner or other molding system under pressure from the feed screw or a plunger unit. A shut off valve assembly is often provided to stop and start the flow of molten material from the barrel to the molding system.

Many screws mount ring check valves at their distal end to prevent melt from flowing back during injection. A typical prior-art ring check valve is shown in FIG. 1 at 5. Ring check valve 5 is mounted at the distal end of a screw 7, and has a ring 9 floatably mounted around a shaft 11 between a tip retainer 13 and a rear seat 15. Ring 9 abuts against the interior surface of an injection barrel 17. During the recovery phase, melt pressure forces the screw 7 rearward, allowing the melt to flow under the ring 9 towards the open end of the barrel 17. During the injection phase, the screw 7 moves forward, bringing the rear seat 15 into contact with the ring 9, and thereby closing off the melt path throughout the remainder of the injection stroke.

As is known to those of skill in the art, ring check valves have simple flow paths (in comparison to other types of check valves), resulting in lower shear rates and fewer hang-up spots for the melt. However, wear of the tip retainer and the ring is a common problem in prior art ring check valves. During recovery, the tip retainer rotates with the screw and the ring freely floats in the barrel. Relative movement of the contact surfaces of both the tip retainer and the ring, loaded with recovery pressure and viscous drag forces, causes the wear failure of these components. The problem is especially severe for high performance machines, which recover using high screw RPMs.

Some prior art ring check valves have used carbide inserts on the tip retainer to increase service life of the wearing components. Unfortunately, because of the small bearing area between wear surfaces, the problem has not been eliminated and failures of this design due to wear still occur.

### SUMMARY OF THE INVENTION

According to a first aspect of the invention, there is provided a check valve for a screw. The check valve has a retainer tip that is operable to be attached to a distal end of a screw shaft, the retainer tip operable to retain a ring assembly. The ring assembly is coaxially mounted around the retainer tip, the ring assembly and the retainer tip operable to cooperatively move between an open position which permits melt to flow through the check valve and a closed position which prevents backflow of the melt. Contact surfaces between the ring assembly and the retainer tip while the ring assembly is in the open position are located proximate to the longitudinal axis of the screw.

According to another aspect of the invention, there is provided a check valve for a screw. The check valve has a retainer tip that is operable to be attached to a distal end of a screw shaft, the retainer tip operable to retain a ring assembly. The ring assembly is coaxially mounted around the retainer tip, the ring assembly and the retainer tip operable to cooperatively move between an open position which permits melt to flow through the check valve and a closed position which prevents backflow of the melt, The ring assembly includes inward-facing flutes that extend towards the retainer tip.

### BRIEF DESCRIPTION OF THE DRAWINGS

The invention and its embodiments will be more fully appreciated by reference to the following detailed description of illustrative (non-limiting) embodiments in accordance with the present invention when taken in conjunction with the accompanying drawings, in which:

FIG. 1 is a side cross-sectional view of a prior-art ring check valve;

FIG. 2 is a side cross-sectional view of an injection molding machine according to a first embodiment of the invention;

FIG. 3 is a perspective view of a check valve for the injection molding machine shown in FIG. 2;

FIG. 4 is a frontal plan view of a check valve for the injection molding machine shown in FIG. 2;

FIG. 5 is a side cross-sectional view of a check valve for the injection molding machine shown in FIG. 2;

FIG. 6 is a perspective view of channels for the check valve shown in FIGS. 2-5;

FIG. 7 is a perspective view of a ring assembly for a check valve for an injection molding machine according to another embodiment of the invention;

FIG. 8 is a perspective view of a ring assembly for a check valve for an injection molding machine according to another embodiment of the invention;

FIG. 9 is a side cross-sectional view of a check valve according to another embodiment of the invention;

FIG. 10 is a side cross-sectional view of a check valve according to another embodiment of the invention;

FIG. 11 is a perspective view of a ring assembly for a check valve for an injection molding machine according to another embodiment of the invention;

FIG. 13 is a perspective cross-sectional view of a ring assembly for a check valve for an injection molding machine according to another embodiment of the invention;

FIG. 13 is a cross-sectional view of a ring assembly for a check valve for an injection molding machine according to another embodiment of the invention;

FIG. 14 is a cross-sectional view of a ring assembly for a check valve for an injection molding machine according to another embodiment of the invention; and

FIG. 15 is a cross-sectional view of a ring assembly for a check valve for an injection molding machine according to another embodiment of the invention.

### DETAILED DESCRIPTION OF THE NON-LIMITING EMBODIMENTS

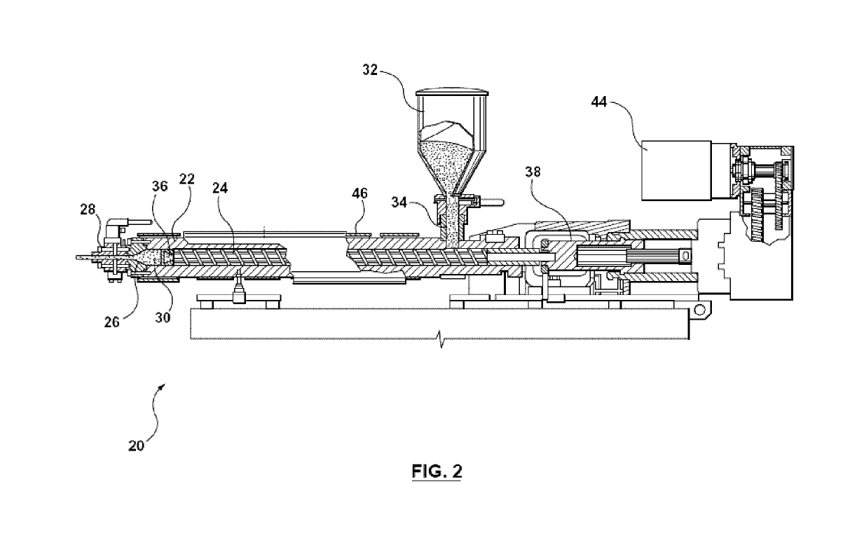

Referring now to FIG. 2, an injection unit for a molding system in accordance with a first non-limiting embodiment is shown generally at 20. The injection unit 20 includes an extrusion barrel 22 adapted to receive an injection screw 24. Extrusion barrel 22 may include an optional protective liner (not shown). A cylinder head 26 closes off the end of extrusion barrel 22, and mounts a nozzle 28, coaxially aligned therewith. A melt channel 30 is defined between them, extending through extrusion barrel 22, cylinder head 26 and nozzle 28.

Resin material (typically thermoset or thermoplastic pellets) is fed from a hopper 32, through a feed throat 34 into melt channel 30. The rotational movement of screw 24 plasticizes the material prior to it exiting through nozzle 28. In some embodiments, screw 24 may include a plurality of specialized zones (not shown). For example, a first zone might include screw flights adapted for conveying solid material from the hopper 32, a latter zone for shearing and plasticizing the material, and a final zone for mixing the now-molten material prior to exiting through nozzle 28. Screw 24 may also include weirs or channels to separate out unmelted material from the melted material for further processing. Other adaptations will occur to those of skill in the art.

In addition to rotating, screw 24 is, in some embodiments, operable to reciprocate back and forth to express the melted material out through nozzle 28 and pack the material within a mold (not shown). A ring-check valve 36 is provided near the tip of screw 24 to prevent the reentry of the melted material during the forward motion of the screw 24 during its injection phase. The rotational movements of screw 24 is provided by a motor 44, which may be an electric motor, a hydraulic motor, or a combination thereof (the embodiment depicted in FIG. 2 shows an electric version of motor 44). The rotational movement of screw 24 helps to melt and mix the melted material. Screw 24 is also translatable within extrusion barrel 22 via piston 38, in order to apply injection and hold pressure during the molding process.

Heater bands 46 are provided along a portion of the length of extrusion barrel 22 (though away from the feed throat 34) to assist in the melting of the material (in addition to the heat generated by the shearing action of screw 24) and then maintain the temperature of the molten material as it approaches the nozzle 28. In some embodiments, heater bands 46 are covered with an insulating barrel cover to minimize heat loss). Thermocouples are provided along the extrusion barrel 22 to provide an indication of the melted material's temperature.

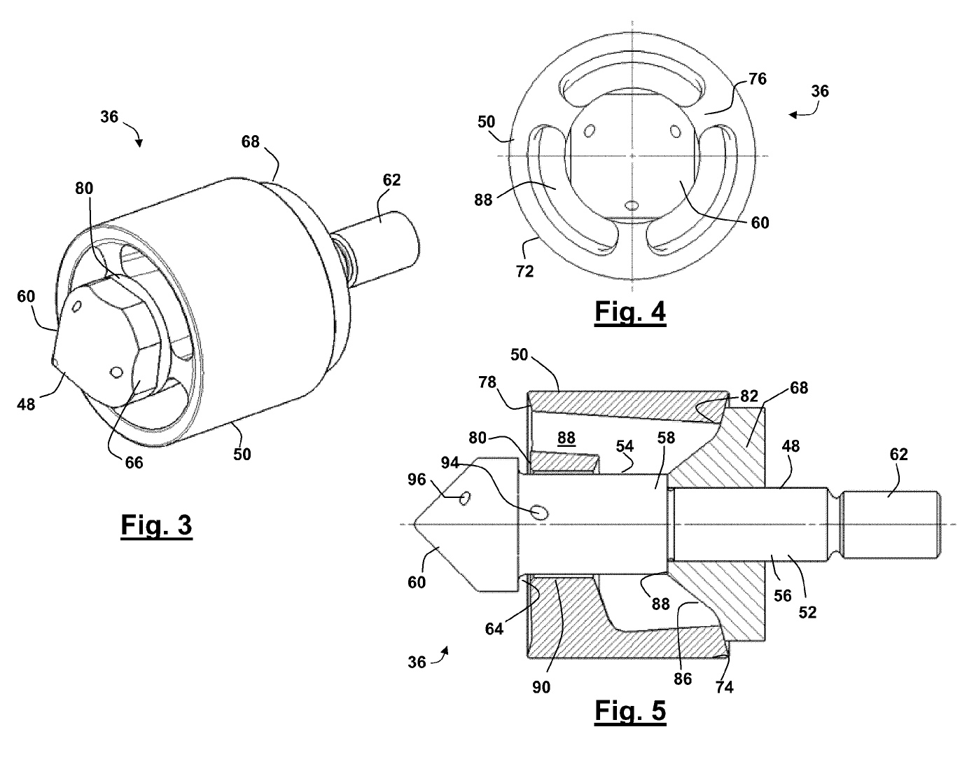

Referring now to FIGS. 3-5, ring check valve 36 is described in greater detail. FIGS. 3-5 show ring check valve 36 in the closed position. Ring check valve 36 includes a retainer tip 48 and a ring assembly 50.

Retainer tip 48 includes a shaft 52 and a tip portion 60 at a distal or forward end of shaft 52. In the presently-illustrated embodiment, shaft 52 has a wider portion 54 and a thinner portion 56, with a step 58 between wider portion 54 and thinner portion 56. However, a shaft having either a constant diameter or other variations in diameter could also be used. In some embodiments, the opposing end of shaft 52 defines an interface 62 adapted to be removably mated with a complementary-interface on the end of screw 24 (FIG. 2). Once mounted, retainer tip 48 is kinematically coupled with screw 24 and thus rotates and translates in tandem with the screw. Optionally, a spacer (not shown) can be attached to an end of shaft 52 by a fastener (not shown) to prevent the retainer tip 48 from bottoming out in the screw 24.

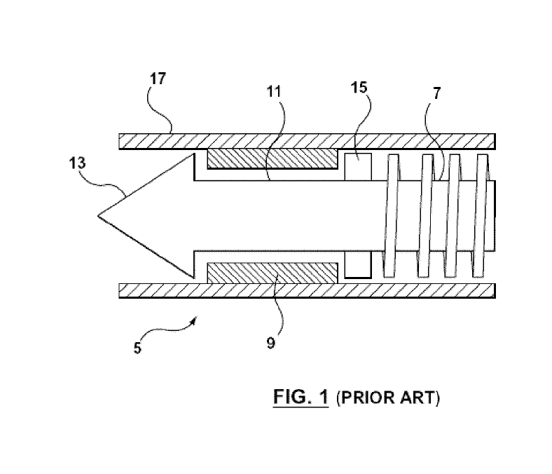

Tip portion 60 is generally conically shaped, and has a greater diameter than shaft 52 so that it provides a ledge extending beyond the wider portion 54 of shaft 52 that defines a front seat 64 for preventing removal of ring assembly 50 in a forward direction. Tip portion 60 is smaller in diameter than ring assembly 50, and is also smaller than typical prior art retainer tips (such as the one shown in FIG. 1). As the tip portion 60 has a narrower diameter, it can also have a shorter length while maintaining the same slope of the conical portion, thereby reducing the length of retainer tip 48. Optionally, the tip portion 60 provides a plurality of longitudinally-aligned cut-outs 66. The cut-outs 66 provide gripping surfaces when the retainer tip 48 is mounted or dismounted from the screw 24. In the presently-illustrated embodiment, the cut-outs 66 are comparatively broad and shallow compared to prior art retainer tip flutes.

Retainer tip 48 further includes a rear seat 68 extending outwards from shaft 52 and located between tip portion 60 and interface 62. Rear seat 68 is sized as to provide a smaller diameter than extrusion barrel 22 so that it provides a clear flow path for melt travelling through extrusion barrel 22 when ring check vale 36 is in the open position. In the presently-illustrated embodiment, rear seat 68 includes a seating portion 82 for seating ring assembly 50 and a sloped portion 86 that extends within the ring assembly 50 and helps smooth the melt flow. Rear seat 68 can also include a forward wall 88 that abuts against step 58 on shaft 52 to help prevent forward travel of the rear seat 68.

Ring assembly 50 is floatably and concentrically mounted around shaft 52 between front seat 64 and rear seat 68. Ring assembly 50 includes a ring 72 that is sized as to abut against the inside of extrusion barrel 22 (FIG. 2). In the currently-illustrated embodiment, the thickness of ring 72 diminishes on its inward side as it moves from its rearward edge 74 towards its forward edge 78. Ring assembly 50 further includes an inner ring 80 that is also concentrically located around shaft 52. In some embodiments, the thickness of inner ring 80 increases as it moves from its rearward edge to its forward edge so that the distance between the facing surfaces of ring 72 and inner ring 80 remains substantially constant. In some embodiments, the thickness of inner ring 80 at its forward edge should be the same as the height of the front seat 64. In the presently-illustrated embodiment, the length of inner ring 80 is less than that of ring 72. A plurality of inward-facing flutes 76 maintain spacing between ring 72 and inner ring 80. In the presently-illustrated embodiment, flutes 76 are tapered as to narrow as they approach inner ring 80.

The space between ring 72 and the inner ring 80 provides a throughput region 88. As flutes 76 generally do not see excessive wearing, they can be comparatively thin relative to prior art flutes which are located on the screw, helping to increase the cross-sectional area of throughput region 88. Tip portion 60 is sized as to minimally occlude throughput region 88 by not extending past inner ring 80.

Operation of ring check valve 36 is similar to that of prior-art designs. During the recovery phase, melt pressure forces the screw 24 (including the attached retainer tip 48 and ring assembly 50) in a rearward direction, moving ring check valve 36 into its open position, allowing the melt to flow under the ring 72 (which remains substantially in place against the interior surface of extrusion barrel 22), and through throughput regions 88 towards the end of the extrusion barrel 22. During the recovery phase, the front surface of inner ring 80 provides a contact surface which abuts against an opposing contact surface on the tip portion 60, namely front seat 64. Relative (i.e., rotational) movement between contact surfaces on the retainer tip 48 and ring assembly 50 occurs proximate to the axis of screw 24, which is closer to the axis of screw 24 than in prior-art check valves, and at a lower speed, thereby reducing wear damage to ring check valve 36. In addition, inner ring 80 provides a comparatively large contact surface for front seat 64, further reducing wear. During the injection phase, the screw 24 moves forward, bringing the seating portion 82 of rear seat 68 into contact with the rearward edge 74 of ring 72, and thereby sealing off the melt path for the remainder of the injection stroke.

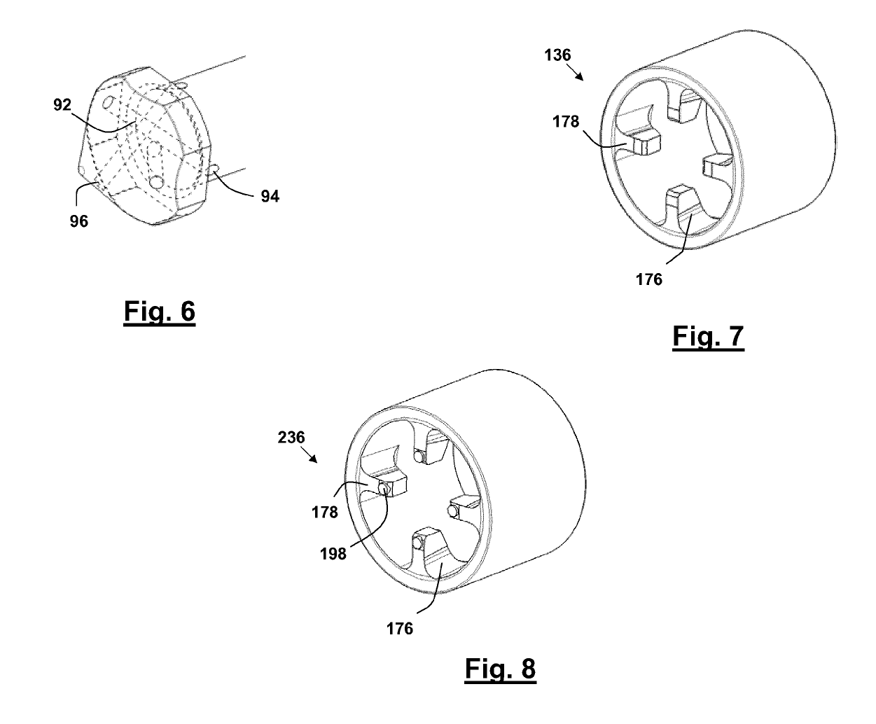

To reduce the amount of melt that is trapped between opposing surfaces of retainer tip 48 and inner surface 90 on inner ring 80, at least one channel 92, and optionally, multiple channels 92 (FIG. 6) can be added to provide an additional exit path for expression of the melt. An inlet 94 for each channel 92 is located on the shaft 52 near the tip portion 60, and an outlet 96 for each channel 92 is located on the conical end of each tip portion 60. Channels 92 are typically drilled through retainer tip 48. Optionally, each channel 92 (relative to the longitudinal axis of retainer tip 48) is oriented and/or sized to facilitate a pumping effect on the melt (generated by rotation of the retainer tip 48).

Referring now to FIG. 7, an additional embodiment of the invention is shown. In this embodiment, a ring check valve 136 is provided that omits an inner ring. Instead, flutes 176 provide a forward edge 178 to provide a contact surface with forward seat. While this configuration reduces the contact surface of the forward seat, it also reduces the area where melt can be trapped and subject to degradation.

Referring now to FIG. 8, an additional embodiment of the invention is shown. In this embodiment, a ring check valve 236 is provided that also omits an inner ring. At least one insert 198, and, optionally, a plurality of inserts 198 can be provided on the forward edge 178 of flutes 176 to provide additional wear life. Inserts 198 are typically disks or filaments made of carbide that have been brazed or welded to the forward edge 178 of the flutes 176. The inserts 198 are not particularly limited by shape and may contain hydrodynamic features. Alternatively, in embodiments of the invention having an inner ring, the inserts 198 can be mounted to the forward edge of the inner ring (not shown).

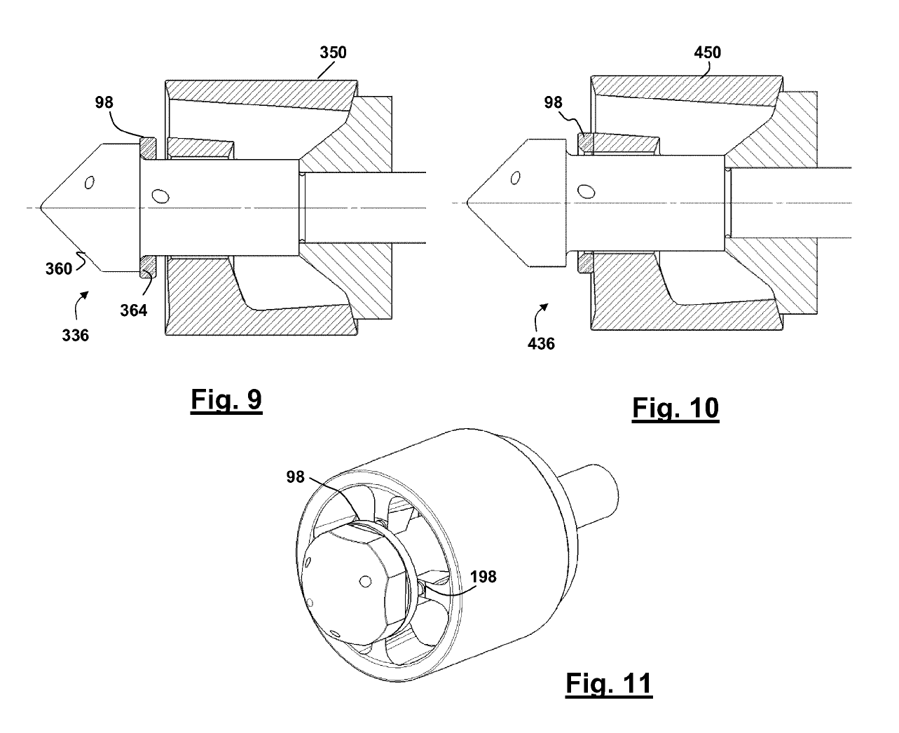

Referring now to FIGS. 9 and 10, two additional embodiments of the invention are shown. In these embodiments, a ring check valve 336 and 436 respectively is presented, having a wear ring 98 located between the front seat of the retainer tip and the ring assembly. In FIG. 9, the wear ring 98 is fixed on the front seat 364 of tip portion 360. In FIG. 10, the wear ring 98 is fixed on the ring assembly 450. Alternatively, the wear ring 98 could float freely between the retainer tip and the ring assembly (not shown). The wear ring 98 is a replaceable part, and typically is manufactured from a ceramic material such as zirconium oxide. For greater resiliency, the use of a wear ring 98 could be combined with the use of inserts 198, as is shown in FIG. 11.

Referring now to FIG. 12, an additional embodiment is shown. A ring check valve 536 is provided having additional lubrication functionality. Located on a front seat 564 of tip portion 560 is a cutaway portion 580, which provides a small gap between front seat 564 and the forward edge 78 of the inner ring 80. During recovery, melt pressure forces a small amount of the melt out through cutaway portion 580. Rotation of retainer tip 548 causes the leaked melt to be spread across the interface between front seat 564 and forward edge 78, creating hydrodynamic lubrication and reduced wear of the ring check valve 536.

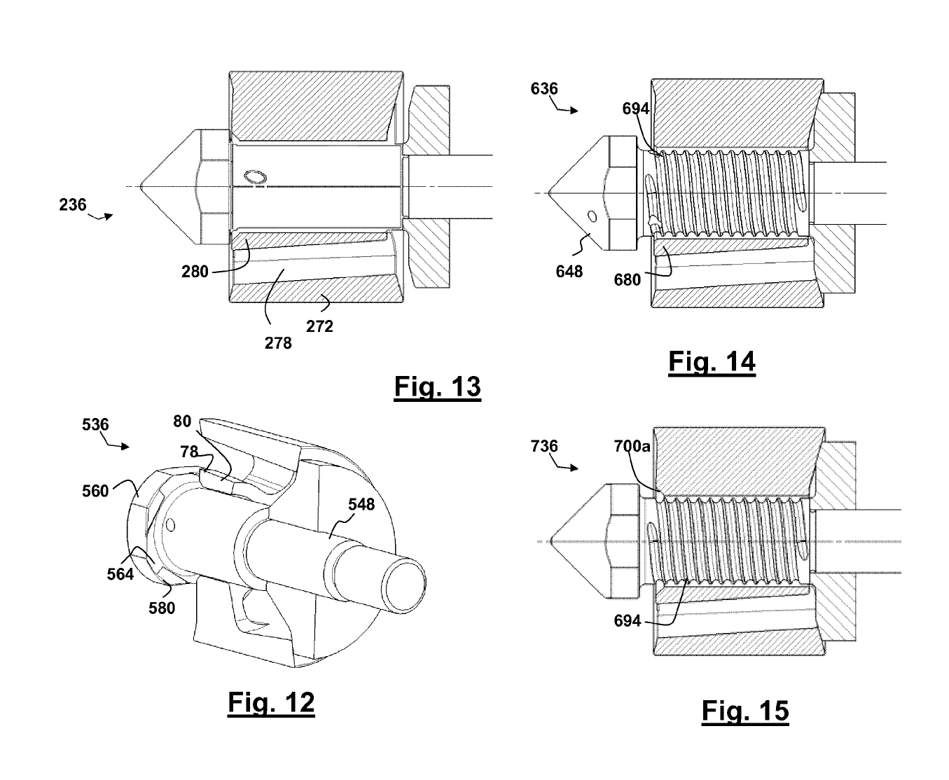

Referring now to FIG. 13, an additional embodiment of the invention is shown. A ring check valve 236 is provided where inner ring 280 has a length substantially equivalent to ring 272. Flutes 278 also extend substantially fully along the length of ring 272.

Referring now to FIG. 14, an additional embodiment is shown. A ring check valve 636 is provided having additional lubrication functionality. Threads 694 are provided on retainer tip 648 on an opposing surface underneath the inner ring 680, which act as a screw pump to move melt located there between. Alternatively, threads could be provided on a surface of the inner ring opposing the retainer tip (not shown).

Referring now to FIG. 15, an additional embodiment is shown. A ring check valve 736 is provided having additional lubrication functionality. Like the embodiment shown in FIG. 14, threads 694 are provided to act as a screw pump to move melt. An undercut 700 (i.e., having a chamfer) is located on the forward edge 678 of the inner ring 580 to help the melt exit from underneath the inner ring. In addition, the exiting melt works to force the inner ring 680 away from front seat 664, thereby reducing wear.

The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claims.

1. A ring-check valve for an injection screw, comprising:
a retainer tip being operable to be attached to a distal end of the injection screw;
a ring assembly being coaxially mounted around the retainer tip, the ring assembly and the retainer tip operable to cooperatively move between: (i) an open position which permits melt to flow through the ring-check valve, and (ii) a closed position which prevents backflow of the melt; and
the retainer tip being rotatable and translatable,
the retainer tip including:
a shaft;
a tip portion at a forward end of shaft; and
a rear seat extending outwards from the shaft, the rear seat including a seating portion; and
the ring assembly including:
a ring being sized as to abut against an inside of an extrusion barrel, the seating portion for seating the ring when the ring-check valve is in the closed position;
an inner ring being concentrically located around the shaft of the retainer tip;
a plurality of inward-facing flutes maintaining a spacing between the ring and the inner ring, the spacing between the ring and the inner ring providing a throughput region, and the tip portion being sized as to minimally occlude the throughput region by not extending past the inner ring.

2. The ring-check valve of claim 1, wherein the ring assembly includes inward-facing flutes that extend towards the retainer tip.

3. The ring-check valve of claim 2, wherein:
the inner ring is located around the shaft on the retainer tip, the inner ring interconnecting the inward-facing flutes, and providing a contact surface on the inner ring while the ring assembly is in the open position.

4. The ring-check valve of claim 2, wherein:
the ring sized to be in contact with an inner surface of the extrusion barrel, the inward-facing flutes extending from the ring towards the shaft on the retainer tip.

5. The ring-check valve of claim 4, wherein the inward-facing flutes are shorter than the ring.

6. The ring-check valve of claim 4, wherein a thickness of the ring diminishes from its rearward edge to its forward edge.

7. The ring-check valve of claim 1, wherein:
the shaft, operable to be coaxially mounted to the distal end of the injection screw;
the tip portion at a forward end of the retainer tip, the tip portion having a greater diameter than the shaft, the ring assembly operable to stop movement of the ring assembly in a forward direction, and further provide a contact surface on the retainer tip; and
the rear seat, extending radially from the shaft, operable to stop movement of the ring assembly in a rearward direction, the rear seat further operable to block the melt from flowing through the ring-check valve when engaged with the ring assembly.

8. The ring-check valve of claim 1, wherein the retainer tip includes at least one channel formed therethrough for facilitating expression of the melt located between opposing surfaces of the ring assembly and the retainer tip.

9. The ring-check valve of claim 2, wherein one of the ring assembly and the retainer tip includes at least one insert located between contact surfaces on the ring assembly and the retainer tip to mitigate wear on the one of the ring assembly and the retainer tip.

10. The ring-check valve of claim 9, wherein the at least one insert includes a wear ring coaxially mounted around the retainer tip between the tip portion of the retainer tip and the inward-facing flutes on the ring assembly.

11. The ring-check valve of claim 9, wherein the at least one insert are carbide inserts mounted to a contact surface of one of the ring assembly and the retainer tip.

12. The ring-check valve of claim 2, wherein:
the inner ring located around the shaft on the retainer tip, the inner ring interconnecting the inward-facing flutes, the inner ring further having an undercut for facilitating expression of the melt located between opposing surfaces of the ring assembly and the retainer tip.

13. The ring-check valve of claim 1, wherein an opposing surface on one of the ring assembly and the retainer tip is threaded to facilitate expression of the melt located therebetween.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)
